(19) United States
(12) Patent Application Publication
(10) Pub. No.: US 2025/0180692 A1
(43) Pub. Date: Jun. 5, 2025

(54) METHOD FOR OPERATING A COOPERATIVE RADAR NETWORK

(71) Applicant: Robert Bosch GmbH, Stuttgart (DE)

(72) Inventors: Carsten Naber, Gerlingen (DE); Daniel Schindler, Korntal-Münchingen (DE); Rossen Michev, Stuttgart (DE)

(21) Appl. No.: 18/956,071

(22) Filed: Nov. 22, 2024

(30) Foreign Application Priority Data
Dec. 4, 2023 (DE) 10 2023 212 149.2

(51) Int. Cl. G01S 7/02; G01S 7/35; G01S 13/00

(52) U.S. Cl. CPC G01S 7/0235; G01S 7/0232; G01S 7/35; G01S 13/003

(57) ABSTRACT

A method for operating a cooperative multiple-input multiple-output (MIMO) radar network with a plurality of analog radar sensors and at least one digital radar sensor. The method includes determining the deviation of the transmission time points and transmission frequencies of at least the plurality of analog radar sensors in relation to one another, and adjusting the transmission time points, reception time points, and transmission frequencies of the signals of at least the plurality of analog radar sensors to one another. A method for interference detection and interference avoidance is also described. A cooperative multiple-input multiple-output (MIMO) radar network including a plurality of analog radar sensors and at least one digital radar sensor is also described.

### CROSS REFERENCE

The present application claims the benefit under 35 U.S.C. § 119 of German Patent Application No. DE 10 2023 212 149.2 filed on Dec. 4, 2023, which is expressly incorporated herein by reference in its entirety.

### FIELD

The present invention relates to a cooperative multiple-input multiple-output (MIMO) radar network and to a method for operating such a network. In particular, the present invention relates to a method for operating cooperative radar networks used in driver assistance systems of motor vehicles for detecting the environment and to such cooperative radar networks. The present invention furthermore relates to a method for interference detection and interference avoidance during operation of a cooperative radar network.

### BACKGROUND INFORMATION

For radar networks as part of driver assistance systems in motor vehicles, modulation methods that frequency-modulate the signals in a chirp method are typically used. Modern radar networks are so-called multiple-input multiple-output (MIMO) radar networks, which have a plurality of transmitters and a plurality of receivers. For example, each radar sensor may be designed to be a transmitter and a receiver at the same time. In this case, the chirp signals (chirps) are transmitted by multiple transmitters and the reflected signals are received by multiple receivers. By means of a corresponding modulation in a multiplexing method, the transmitter can be determined for each unambiguous signal, and an angle estimation can thus be performed with the aperture of the various monostatic or bistatic signals or with the aperture of a virtual radar network formed from the transmitters and receivers, depending on the multiplexing method used. Typical modulation multiplexing methods include Doppler division multiplexing methods (DDM), time division multiplexing methods (TDM), or code division multiplexing methods (CDM).

Most of such radar networks use frequency-modulated continuous wave (FMCW) radar sensors, which are characterized first and foremost by their high technical maturity and low costs. The necessary signals are generated by means of analog components, for example by voltage-controlled oscillators (VCO). In addition, prior to the analog-digital conversion required for evaluation, the received reflected signals are demodulated by analog mixing with the transmission signal and are thus reduced in bandwidth to a few MHz.

Furthermore, in some conventional radar sensors with broadband digital signal generation (hereinafter referred to in short as digital radar sensors), the signals are generated directly by digital-to-analog converters with sample rates of at least multiple 100 MHz, for example of more than 200 MHz, by means of a specified local oscillator (LO). Reflected signals are also mixed by means of a specified local oscillator and are provided for evaluation by means of an analog-to-digital converter with sample rates of at least multiple 100 MHz, for example of more than 200 MHz, without required analog demodulation. This allows digital radar sensors to operate in a high number of modulation methods, significantly increasing their range of use over analog radar sensors. They are also able to receive the full or large portions of the bandwidth of the signal spectrum used in a radar network, at one time and have very high temporal resolution. However, their manufacture is significantly more complex and expensive than that of conventional analog FMCW sensors.

In addition, a greater number of individual radar sensors of varying designs are increasingly being installed in radar networks for driver assistance systems of motor vehicles. This results in higher flexibility in the possible modulation methods. A common cooperative operating mode is of great advantage; for example, with a common data evaluation, the aperture and thus the angular resolution can be significantly increased or interference between the individual sensors can be reduced or avoided. Such radar networks are also referred to as cooperative radar.

One object of the present invention is to provide a method for efficiently operating different radar sensors and modulation types in a cooperative radar network. A further object of the present invention is to provide a radar network for operation as a cooperative radar network.

### SUMMARY

According to the present invention, these objects may be achieved by the methods and by the radar network having certain features of the present invention. Advantageous developments of the present invention are disclosed herein.

A method according to an example embodiment of the present invention for operating a multiple-input multiple-output (MIMO) radar network comprises the following steps:
generating and transmitting signals; transmitting the signals by means of a plurality of analog radar sensors and at least one digital radar sensor, wherein the plurality of analog radar sensors and the at least one digital radar sensor transmit in a first modulation method; or wherein the plurality of analog radar sensors transmits in a first modulation method and the at least one digital radar sensor transmits in a second modulation method, wherein the transmission spectra of the signals of the first and of the second modulation method do not overlap; receiving and conditioning reflected signals for digital processing, wherein the at least one digital radar sensor receives the transmitted signals of all radar sensors;
determining the deviation of the transmission time points and transmission frequencies of at least the plurality of analog radar sensors in relation to one another by means of the signals received by the at least one digital radar sensor; adjusting the transmission time points, reception time points, and transmission frequencies of the signals of at least the plurality of analog radar sensors to one another; evaluating the received signals in at least one of the monostatic paths of the respective radar sensors, the at least one bistatic path from the at least one analog radar sensor to the digital radar sensor, the respective bistatic paths between the plurality of analog radar sensors and, if the plurality of analog radar sensors and the at least one digital radar sensor transmit in the first modulation method, the respective bistatic paths from the at least one digital radar sensor to the plurality of analog radar sensors.

According to an example embodiment of the present invention, the plurality of analog radar sensors are, for example, frequency-modulated continuous wave radar sensors (FMCW sensors). The at least one digital radar sensor designates a radar sensor with broadband digital signal generation (hereinafter referred to in short as a digital radar sensor) that processes signals with digital-to-analog converters and analog-to-digital converters with sample rates of at least multiple 100 MHZ, for example of more than 200 MHz. Since the at least one digital radar sensor receives the signals of all radar sensors, it is possible, by processing the signals received by it from each of the analog radar sensors, to determine the respective deviation of the transmission time points and transmission frequencies in relation to the other radar sensors and/or in relation to the predetermined transmission time points and transmission frequencies. By correspondingly adjusting by means of correction values for each radar sensor in comparison to the other radar sensors and/or for respective predetermined transmission time points and transmission frequencies and by correspondingly outputting the correction values to the respective radar sensors, the efficiency and accuracy of the radar network can be significantly increased. The adjustment may also be made by adjusting the transmission signals generated for each radar sensor.

It is thus possible, for example, to adjust the analog radar sensors to one another in such a way that an evaluation in the respective bistatic paths between the analog radar sensors is made possible or significantly simplified, depending on deviations existing prior to the adjustment. If an evaluation in the respective bistatic paths between the analog radar sensors is not possible due to the existing deviation, the evaluation can take place only after the signals have been adjusted and the adjusted signals have been transmitted and received again. A bistatic path or a bistatic signal describes the reception of a reflected signal by means of a radar sensor as the receiver that does not correspond to the radar sensor that transmitted the reflected signal, i.e., the receiver does not correspond to the transmitter. In contrast, the monostatic path or a monostatic signal describes the reception of a reflected signal by means of a radar sensor as the receiver that corresponds to the radar sensor that transmitted the reflected signal, i.e., the receiver corresponds to the transmitter. The determination of the deviations is limited by the temporal and frequency-dependent resolution of the at least one digital radar sensor; the temporal resolution for conventional digital radar sensors is in the sub-nanosecond range, for example. Maximum determinable deviations of at least the analog radar sensors may, for example, be multiple microseconds (μs) in their transmission time points and multiple 10 Mhz in their transmission frequencies. The adjustment of the transmission time points, reception time points, and transmission frequencies of the signals may, for example, take place with an accuracy of a few nanoseconds (<1 μs) and in the sub-Mhz range (<1 Mhz). Non-correctable residual deviations, which remain, for example, due to the limits of the temporal and frequency-specific resolution of the analog radar sensors, can be detected by the at least one digital radar sensor and taken into account in the evaluation. The evaluation takes place at least in one of the possible paths, preferably in any combination of the paths, and further preferably in all paths.

The method according to an example embodiment of the present invention is in particular advantageous since robust operation of a radar network operated with the method is achieved through the possible determination and correction of the deviations and a radar network comprising a plurality of analog radar sensors and at least one digital radar sensor can be operated as a cooperative radar network. This ensures high accuracy and robustness while keeping the costs of such a radar network low. Similarly, analog and digital radar sensors can be operated cooperatively, which significantly increases the possible angular resolution, for example.

According to an example embodiment of the present invention, the method may also comprise a plurality of digital radar sensors. In this case, at least one digital radar sensor may transmit in a second modulation method, while the other digital radar sensors transmit in the first modulation method, or all digital radar sensors may transmit in the first or in the second modulation method. The steps described for the at least one digital radar sensor may in this case also be performed by a plurality or all of the plurality of digital radar sensors. Or, they may be performed by one of the plurality of digital radar sensors, wherein the deviation may also be determined for the plurality of digital radar sensors.

According to a preferred embodiment of the method of the present invention, the method may furthermore comprise a preceding step for temporally synchronizing the radar sensors, wherein the synchronization comprises transmitting a separate radar signal at a predetermined time point in order to determine the deviation, and adjusting on the basis thereof; or wherein the synchronization is performed by means of a trigger signal from at least one radar sensor and/or by means of a synchronization protocol and/or by means of a clock signal.

Through the temporal synchronization, the deviations of the radar sensors, in particular of the analog radar sensors to one another, can be reduced even before determining the deviation and adjusting by means of the data measured by the at least one digital radar sensor. This has the advantage that the computational effort for determining the deviations is lower and the signals can thus be adjusted correspondingly more quickly. In the case of an existing deviation of the analog radar sensors in which an evaluation in the respective bistatic paths between the analog radar sensors is not possible, the synchronization can also already make an evaluation possible in the first method run.

A trigger signal from at least one radar sensor may be a signal transmitted at a predetermined time point, which signal is received at least by the plurality of analog radar sensors and the analog radar sensors are temporally synchronized with one another by means of the received signal. Such a synchronization may be an approximate temporal synchronization, which may continue to comprise a deviation of multiple microseconds. A synchronization protocol may, for example, be a precision time protocol (PTP). A clock signal may be a signal output to each radar sensor.

According to a preferred embodiment of the method of the present invention, the first modulation method may be an FMCW method with Doppler division multiplexing methods (DDM) or with time division multiplexing methods (TDM), or with code division multiplexing methods (CDM); and/or the second modulation method may be an orthogonal frequency division multiplexing method (OFDM) or a phase-modulated continuous wave (PMCW) method. In particular, the second modulation method may be a broadband digital modulation method, which can only be performed by the at least one digital radar sensor.

According to another preferred embodiment of the method of the present invention, the evaluation of the signals received from the plurality of analog radar sensors may comprise the demodulation of the respective received signals. This, for example, takes place by demodulation with the transmission signal, whereby the bandwidth of the demodulated signal is reduced to a few megahertz (MHz). The demodulation preferably takes place in the demodulation method that corresponds to the type of the modulation method.

According to another preferred embodiment of the method of the present invention, if the plurality of analog radar sensors and the at least one digital radar sensor transmit in the first modulation method, the evaluation of the signals received by the at least one digital radar sensor comprises separating the monostatic signals of the at least one digital radar sensor from the bistatic signals of the plurality of analog radar sensors by means of optimal filters. Such optimal filters (matched filters) transform the reception signal into a baseband signal, which can subsequently be demodulated by means of a conventional demodulation method. Different optimal filters for signals of the monostatic path and of the bistatic paths may be used, as a result of which the signals of the analog radar sensors can subsequently also be demodulated and evaluated.

If the at least one digital radar sensor transmits in the second modulation method, the evaluation of the signals received by the at least one digital radar sensor comprises separating the monostatic signals of the at least one digital radar sensor from the bistatic signals of the plurality of analog radar sensors by means of frequency masks. Such a frequency mask may, for example, be a time-frequency mask, which can be generated from the transmission signal of the at least one digital radar sensor. The signals that correspond to the monostatic path of the at least one digital radar sensor can thus be filtered out and evaluated. The unfiltered signals correspond to the signals in the bistatic path to the at least one digital radar sensor and can be demodulated and evaluated in the usual manner as described.

The present invention furthermore comprises a method for interference detection and interference avoidance. This method is used in a method for operating a radar network according to one of the embodiments described above and may represent a method performed independently or, as steps of the method for operating a radar network, may also represent an advantageous development thereof. Such a method for interference detection and interference avoidance comprises the steps of determining the frequency bands without and/or with very low interference from the signals received by the at least one digital radar sensor; and adjusting the transmission frequencies of the signals of at least the plurality of analog radar sensors to these frequency bands.

Since the at least one digital radar sensor receives the transmitted signals of all radar sensors, i.e., the full or large portions of the full bandwidth of the used radar band, the interference-free bands can be determined from the signals received by the at least one digital radar sensor. Bands with the lowest possible interference can also be determined. Subsequently, the transmission frequencies of at least the analog radar sensors are shifted into these bands. Preferably, the transmission frequencies are shifted into interference-free bands. If there are more transmission frequencies than interference-free bands, the excess transmission frequencies are shifted into low-interference bands to the extent possible. Subsequently, the method is performed again and a corresponding adjustment is made. By performing the method multiple times or continuously, the ideal frequency bands adjusted to the respective situation can be selected. As a result, interference can be completely avoided or greatly reduced.

According to a preferred embodiment of the method of the present invention, the step of determining the frequency bands without and/or with very low interference from the signals received by the at least one digital radar sensor is performed with the step of determining the deviation of the transmission time points and transmission frequencies of at least the plurality of analog radar sensors in relation to one another by means of the signals received by the at least one digital radar sensor; and/or the step of adjusting the transmission frequencies of the signals of at least the plurality of analog radar sensors to frequency bands without and/or with very low interference is performed with the step of adjusting the transmission time points, reception time points, and transmission frequencies of the signals of at least the plurality of analog radar sensors to one another. For example, the steps in each case are performed simultaneously or in one step. This is therefore in particular advantageous for the method according to the present invention since such an embodiment only requires increased computing capacity and does not otherwise interfere with the operation of the radar network or delay the performance of the method for operating a radar network.

The present invention furthermore comprises a multiple-input multiple-output (MIMO) radar network. According to an example embodiment of the present invention, the MIMO radar network comprises a plurality of analog radar sensors, wherein the plurality of analog radar sensors is designed to transmit and receive signals in a first modulation method; at least one digital radar sensor, wherein the at least one digital radar sensor is designed to transmit and receive signals in the first modulation method or in a second modulation method, wherein the transmission spectra of the signals of the first and of the second modulation method do not overlap, wherein the at least one digital radar sensor is designed to receive the transmitted signals of all radar sensors; wherein the at least one digital radar sensor and the plurality of analog radar sensors are designed to exchange data directly or via an exchange unit; a computing unit, wherein the computing unit is designed to determine the deviation of the transmission time points and transmission frequencies of at least the plurality of analog radar sensors in relation to one another from the signals received by the at least one digital radar sensor, wherein the at least one computing unit is furthermore designed to adjust the transmission time points, reception time points, and 20 transmission frequencies of at least the plurality of analog radar sensors to one another. The exchange unit may be the computing unit.

According to a preferred embodiment of the present invention, the at least one computing unit is furthermore designed to adjust the transmission time points, reception time points, and transmission frequencies of at least the plurality of analog radar sensors to one another in such a way that an evaluation of the received signals is possible in the respective bistatic paths between the plurality of analog radar sensors.

The computing unit may furthermore be designed to adjust the transmission time points and reception time points to match in the range of nanoseconds and/or to adjust the transmission frequencies to predetermined transmission frequencies with an accuracy in the sub-MHz range.

According to a preferred embodiment of the present invention, the at least one digital radar sensor and the plurality of analog radar sensors are designed to be temporally synchronized. Further preferably, the radar network comprises a synchronization protocol and/or a separate radar signal and/or a clock signal.

According to a preferred embodiment of the present invention, the first modulation method is an FMCW method with Doppler division multiplexing methods (DDM) or with time division multiplexing methods (TDM) or with code division multiplexing methods (CDM) and/or the second modulation method is an orthogonal frequency division multiplexing method (OFDM) or a PMCW method.

Preferred embodiments of the present invention are explained in more detail below with reference to the figures.

### BRIEF DESCRIPTION OF THE DRAWINGS

FIG. 1 shows a schematic illustration of an embodiment of the radar network according to an example embodiment of the present invention.

FIG. 2 shows an illustration of the transmission frequency spectrum of a first example embodiment of the method according to the present invention.

FIG. 3 shows an illustration of the transmission frequency spectrum of a second example embodiment of the method according to the present invention.

FIG. 4 shows an illustration of the transmission frequency spectrum of a third example embodiment of the method according to the present invention.

FIG. 5 shows an illustration of the transmission frequency spectrum of a fourth example embodiment of the method according to the present invention.

FIG. 6 shows a schematic illustration of the method steps of the method according to the present invention.

FIG. 7 shows a schematic illustration of the method steps of the method according to an example embodiment of the present invention with interference detection and adjustment.

### DETAILED DESCRIPTION OF EXAMPLE EMBODIMENTS

Below, resolution designates the frequency accuracy and the temporal accuracy with which the various radar sensors can transmit and receive signals. A radar sensor comprises at least one transmitter (Tx) and one receiver (Rx). Time-related terms such as before/after, etc. designate the order of the method steps. Spatial terms relate to the arrangement shown in the figures. The described embodiments may, of course, be combined with one another to the extent technically feasible.

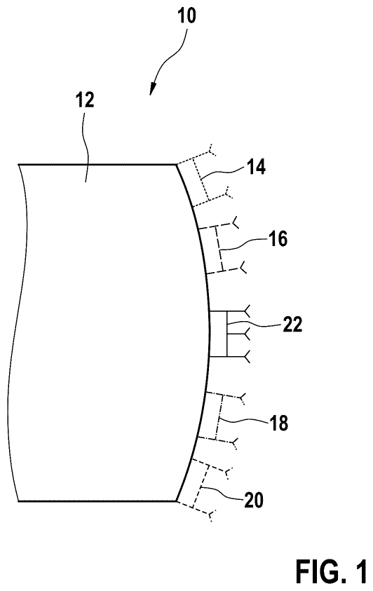

FIG. 1 shows a schematic illustration of an embodiment of the radar network 10 according to the present invention. The radar network is, for example, attached to one side or, for example, to the front of a vehicle 12 and comprises four analog radar sensors 14, 16, 18, and 20, which are distributed along the front of the vehicle 12 and have defined distances from one another. In the present embodiment, each analog radar sensor 14-20 comprises a transmitter (Tx) and a receiver (Rx). The transmitter may be the receiver at the same time, but each radar sensor may also comprise separate transmitters and receivers. In the present embodiment, transmitters and receivers are in each case arranged together but may, for example, be arranged separately from one another, for example along the side of the vehicle 12. Each analog radar sensor may also comprise multiple transmitters and receivers. Furthermore, the radar network 10 comprises a digital radar sensor 22. In the illustrated embodiment, this digital radar sensor is arranged centrally between the analog radar sensors 14 to 20 but is, of course, not limited to this arrangement. The digital radar sensor 22 comprises at least one transmitter and one receiver.

The radar network 10 is designed to detect radial velocities, distances, and azimuth angles as well as elevation angles of targets as part of a driver assistance system of the vehicle 12 and to feed them into the driver assistance system. In this case, the signals may be detected in the monostatic paths of the individual analog radar sensors 14-20 and/or the monostatic path of the digital radar sensor 22. A monostatic path corresponds to a signal transmitted by a radar sensor 14-22 and received by this radar sensor. Depending on the operating method of the radar network 10, the bistatic paths between the individual analog radar sensors 14-20 and/or between each analog radar sensor 14-20 and the digital radar sensor 22 may also be detected. A bistatic path corresponds to a signal transmitted by one radar sensor 14-22 and received by another radar sensor 14-22.

The analog radar sensors 14-20 are designed to be operated in a multiplexing method. Depending on the operating mode, the multiplexing method is a DDM, TDM, or CDM multiplexing method, for example. The digital radar sensor 22 is designed to be operated in a broadband digital modulation method, such as an OFDM method, or to be operated in an FMCW method with DDM, TDM, or CDM multiplexing methods. If the digital radar sensor is operated in a different modulation method than the analog radar sensors, only the bistatic paths from each analog radar sensor to the digital radar sensor can be detected, i.e., signals transmitted from the analog radar sensors can be received by the digital radar sensor. The digital radar sensor is designed to detect the full or large portions of the bandwidth of the transmitted signals. If the digital radar sensor is operated in the same modulation method as the analog radar sensors, the bistatic paths from the digital radar sensor to each analog radar sensor can also be detected by the latter.

The radar network 10 furthermore comprises at least a first computing unit (not shown here), which is designed to determine, from the signals received by the digital radar sensor 22, the respective deviation of the transmission time points and transmission frequencies of the analog radar sensors 14-20 in relation to one another. The radar network 10 furthermore comprises a second computing unit (not shown here), which is designed to adjust the transmission time points, reception time points, and transmission frequencies of the analog radar sensors 14-20 to one another. The first and second computing units may be the same computing unit. Furthermore, at least one computing unit is designed to evaluate the reception signals of the plurality of the analog and digital radar sensors together in terms of distance, relative velocity, and azimuth/elevation angles of the reflections.

The radar sensors 14-22 are designed to communicate with the at least one computing unit and/or the first and/or the second computing unit. Furthermore, the radar sensors 14-22 may be designed to communicate directly with one another and to be able to exchange data directly or via an exchange unit. The at least one computing unit may in this case be the exchange unit.

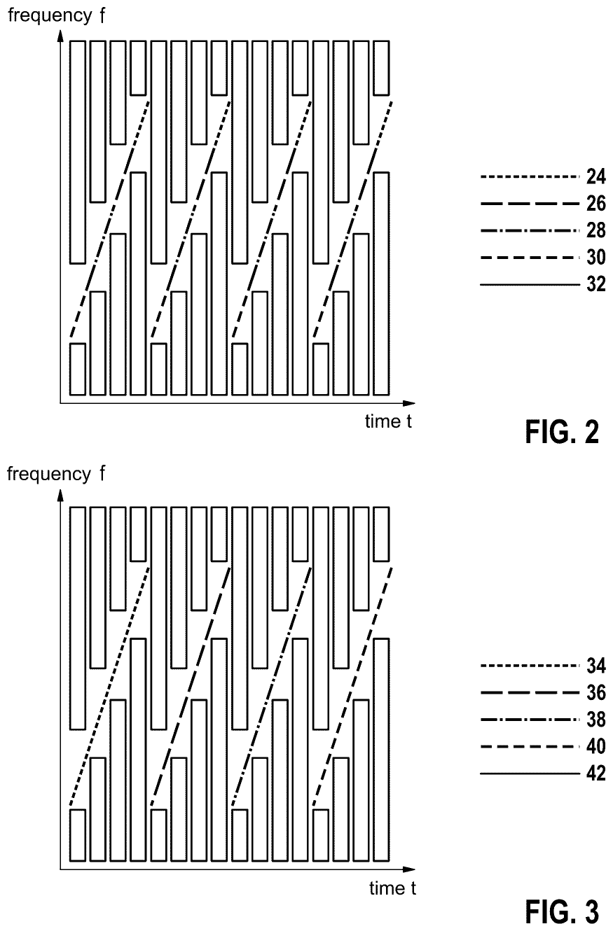

FIG. 2 shows an illustration of the transmission frequency spectrum of a first embodiment of the method according to the present invention for operating a radar network. Here, the analog radar sensors 14-20 of the radar network 10 of FIG. 1 are operated in a first modulation method, in which the separation of the simultaneously transmitted signals is possible on the basis of the coding, for example by means of a DDM method. Each radar signal of the analog radar sensors 14-20 is transmitted simultaneously as a chirp with increasing frequency f over time t. Radar sensor 14 transmits the signals 24, radar sensor 16 transmits the signals 26, radar sensor 18 transmits the signals 28, radar sensor 20 transmits the signals 30.

The digital radar sensor 22 of FIG. 1 transmits signals 32 in a second modulation method, here, for example, in a broadband modulation such as an OFDM method. The radar sensors 14-22 are operated in such a way that the signals 24-30 of the radar sensors 14-20 do not overlap with the signals 32 of the digital radar sensor 22. For example, the signals 32 are modulated to have a frequency offset and/or time offset relative to the signals 24-30.

FIG. 3 shows an illustration of the transmission frequency spectrum of a second embodiment of the method according to the present invention. Here, the analog radar sensors 14-20 of the radar network 10 of FIG. 1 are operated in a first modulation method, in which the separation of the transmitted signals is possible through a time offset during transmission, for example by means of a TDM method. Each radar signal of the analog radar sensors 14-20 is transmitted in an individual time slot as a chirp with increasing frequency f over time t. Radar sensor 14 transmits the signals 34, radar sensor 16 transmits the signals 36, radar sensor 18 transmits the signals 38, radar sensor 20 transmits the signals 40. The digital radar sensor 22 of FIG. 1 transmits signals 42 in a second modulation method, here, for example, in a broadband modulation such as an OFDM method. The radar sensors 14-22 are operated in such a way that the signals 34-40 of the radar sensors 14-20 do not overlap with the signals 42 of the digital radar sensor 22. For example, the signals 42 are modulated to have a frequency offset and/or time offset relative to the signals 34-40.

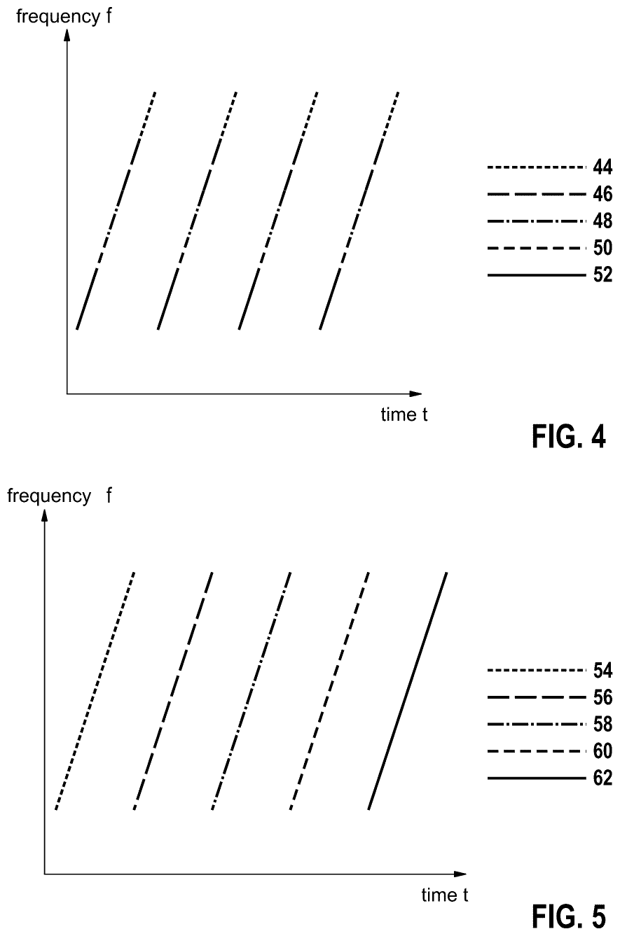

FIG. 4 shows an illustration of the transmission frequency spectrum of a third embodiment of the method according to the present invention. Here, the analog radar sensors 14-20 and the digital radar sensor 22 of the radar network 10 of FIG. 1 are operated in a first modulation method, in which the separation of the simultaneously transmitted signals is possible on the basis of the coding, for example by means of a DDM method. Each radar signal of the radar sensors 14-22 is transmitted simultaneously as a chirp with increasing frequency f over time t. Radar sensor 14 transmits the signals 44, radar sensor 16 transmits the signals 46, radar sensor 18 transmits the signals 48, radar sensor 20 transmits the signals 50, and the digital radar sensor 22 transmits the signals 52.

FIG. 5 shows an illustration of the transmission frequency spectrum of a fourth embodiment of the method according to the present invention. Here, the analog radar sensors 14-20 and the digital radar sensor 22 of the radar network 10 of FIG. 1 are operated in a first modulation method, in which the separation of the transmitted signals is possible through a time offset during transmission, for example by means of a TDM method. Each radar signal of the radar sensors 14-22 is transmitted in an individual time slot as a chirp with increasing frequency f over time t. Radar sensor 14 transmits the signals 54, radar sensor 16 transmits the signals 56, radar sensor 18 transmits the signals 58, radar sensor 20 transmits the signals 60, and the digital radar sensor 22 transmits the signals 62.

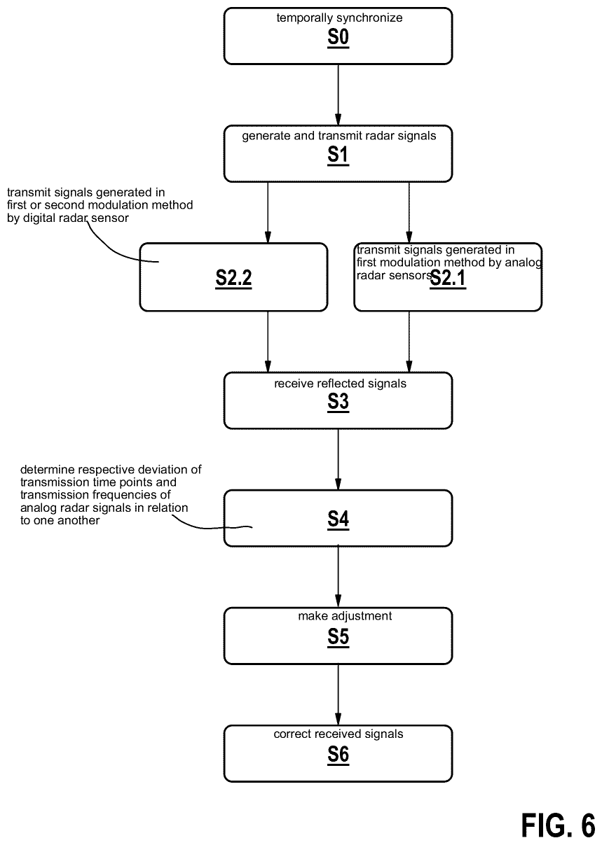

FIG. 6 shows a schematic illustration of the method steps of the method according to the present invention according to any embodiment of FIGS. 2 to 5. The method may be performed with the radar network 10 of FIG. 1 and is described below with reference thereto. Of course, it is not limited to the performance with the radar network of FIG. 1, the reference is merely for clarity and the method can also be operated on another suitable radar network.

The method comprises a step S1 of generating and transmitting radar signals to a plurality of radar sensors, e.g., the radar sensors 14-22. The signals may be generated in two variants. In a first and a second embodiment of the method of FIG. 6, the signals are, for example, generated as a transmission frequency spectrum, as shown in FIGS. 2 and 3. Here, the signals for the analog radar sensors 14-20 are generated in a first modulation method, and the signals for the at least one digital radar sensor 22 are generated in a second modulation method. The signals are generated in such a way that the signals intended for the at least one digital radar sensor 22 do not overlap with the signals intended for the plurality of analog radar sensors 14-20.

In a third and a fourth embodiment of the method of FIG. 6, the signals are, for example, generated as a transmission frequency spectrum, as shown in FIGS. 4 and 5. Here, the signals for the plurality of analog radar sensors 14-20 and for the at least one digital radar sensor 22 are generated in a first modulation method.

In step S2.1, the signals generated in a first modulation method are transmitted by means of the analog radar sensors 14-20. In a simultaneously performed step S2.2, the signals generated in a first or in a second modulation method are transmitted by means of the at least one digital radar sensor 22. In this case, the signals may be transmitted by means of all radar sensors 14-22 simultaneously and/or at predetermined time slots, depending on the modulation method.

The transmitted signals are reflected by targets located in the viewing range of the radar network 10, i.e., for example, in front of the vehicle 12. In step S3, the reflected signals are subsequently received by at least the one digital radar sensor 22 and conditioned for digital signal processing. The digital radar sensor receives the reflected signals of all radar sensors 14-22, i.e., the full bandwidth of the frequencies used. In so doing, the signals received by the digital radar sensor may be provided for evaluation by means of an analog-to-digital converter at sample rates of at least multiple 100 MHZ, for example of more than 200 MHZ, without required analog demodulation. This makes it possible, for example, to prevent a loss of bandwidth and to provide detailed information about the signal frequencies for signal processing. In addition, due to its very good temporal resolution in the sub-nanosesecond range, the digital radar sensor may also provide accurate time information in addition to the detailed frequency information.

This makes it possible to determine the respective deviation of the transmission time points and transmission frequencies of the analog radar sensors in relation to one another in step S4. The deviation in each case designates a determined temporal deviation of the transmission time points and/or a determined deviation of the frequency curve. In a first embodiment of the method of FIG. 2, the deviation of the signals 24-30 to one another and thus the deviation of the radar sensors 14-20 to one another may be determined, for example. Such a deviation may, for example, be a temporal deviation of the transmission time points. In a second embodiment of the method of FIG. 3, a deviation of the frequency curve of the signals 24-30 to one another and thus the deviation of the radar sensors 14-20 to one another may be determined, for example.

Such a determination is in particular simplified in that the signals 32 or 42 of the digital radar sensor 22 can be filtered out of all received signals by means of an optimal filter and used to determine the deviation. Due to the high accuracy of the 25 digital radar sensor 22, the deviation of the signals 24-30 or 34-40 can be determined in a simplified and accelerated manner by comparing the monostatic signals of the digital radar sensor 22 to the bistatic signals of the analog radar sensors 14-20 to the digital radar sensor 22. In particular, propagation time differences generated by the distances of the analog radar sensors 14-20 to the digital radar sensor 22 can be taken into account as a result.

In a third embodiment of the method of FIG. 4, the deviation of the signals 44-52 to one another and thus the deviation of the radar sensors 14-22 to one another may be determined, for example. Since the analog radar sensors and the digital radar sensor in such an embodiment transmit in a first common modulation method, a deviation may, for example, be determined directly from a comparison of all received signals to one another and/or, for example, from a comparison of the monostatic signals of the digital radar sensor to the bistatic signals of the analog radar sensors to the digital radar sensor.

In a fourth embodiment of the method of FIG. 5, the deviation of the signals 54-62 to one another and thus the deviation of the radar sensors 14-22 to one another may be determined, for example. Since the analog radar sensors and the digital radar sensor in such an embodiment transmit in a first common modulation method, a deviation may, for example, be determined directly from a comparison of all received signals to one another and/or, for example, from a comparison of the monostatic signals of the digital radar sensor to the bistatic signals of the analog radar sensors to the digital radar sensor.

In step S4, it is possible to determine deviations that, for example, are multiple microseconds (μs) in their transmission time points and multiple 10 MHz in their transmission frequencies. The limits of the determinable deviations or the determinable deviation range are determined by the modulation method used and by the resolution of the digital radar sensor. If the deviations are outside the determinable limits or the determination of the deviation is to be simplified, the method may furthermore comprise a step S0 of temporally synchronizing. This step synchronizes at least the analog radar sensors prior to signal transmission in such a way that their deviation is within the determinable deviation range. This also reduces the computational effort required to determine the deviation in step S4, since the deviation only has to be determined within the limits determined by the synchronization performed in step S0. A synchronization may, for example, be performed by means of a synchronization protocol but is not limited thereto.

After the deviation has been determined in step S4, an adjustment can subsequently be made in step S5. Such an adjustment includes values and data that specify the deviation of the respective analog radar sensors 14-20. The adjustment may take place in such a way that the received signals are corrected by means of the correction values and can subsequently be evaluated in step S6. Alternatively or additionally, the adjustment may take place in such a way that the transmission signals, generated in step S1, of the respective analog radar sensors 14-20 are adjusted by means of the correction values in such a way that subsequently transmitted signals no longer have any deviation. The adjustment may also take place in such a way that the analog radar sensors 14-20 transmit their transmission signals corrected by means of the correction values. In this case, the adjustment can take place with an accuracy of a few nanoseconds (<1 μs) and in the sub-MHz range (<1 Mhz) and is limited by the resolution of the analog radar sensors, which is usually less than the resolution of the digital radar sensor.

The adjustment in step S5 can achieve that the deviation of the signals of the analog radar sensors to one another is so low that the bistatic paths of the analog radar sensors to one another can be evaluated. That is to say, the signals transmitted by any one of the analog radar sensors 14-20 may be received and evaluated by another analog radar sensor 14-20. As a result, an evaluation is possible even with the lower resolution of the analog radar sensors. It is possible, for example, to evaluate a larger virtual aperture, which may be formed from the various evaluable signal paths.

The determination of the deviation (step S4) and the adjustment (step S5) may take place only at the beginning of the operation of the radar network 10 according to one embodiment of the method according to the present invention. Preferably, these steps are performed at regular intervals or continuously during operation. This improves the accuracy of the radar network and of the method since any deviations that arise are detected and corrected promptly or without delay.

In step S6, the available signals, which may vary depending on the embodiment, are evaluated. This includes the monostatic paths of the respective analog radar sensors and of the digital radar sensor, the bistatic paths from each analog radar sensor to the digital radar sensor, and the bistatic paths of the analog radar sensors to one another. In one embodiment in which all radar sensors transmit in a first modulation method, as shown, for example, in FIGS. 4 and 5, the bistatic paths of the digital radar sensor to each analog radar sensor may also be evaluated.

In this case, a deviation that continues to exist and is below the resolution limits of the accuracy of the analog radar sensors may be taken into account. That is to say, deviations that cannot be adjusted technically can be detected as a result of the higher resolution of the digital radar sensor and can be taken into account in the evaluation.

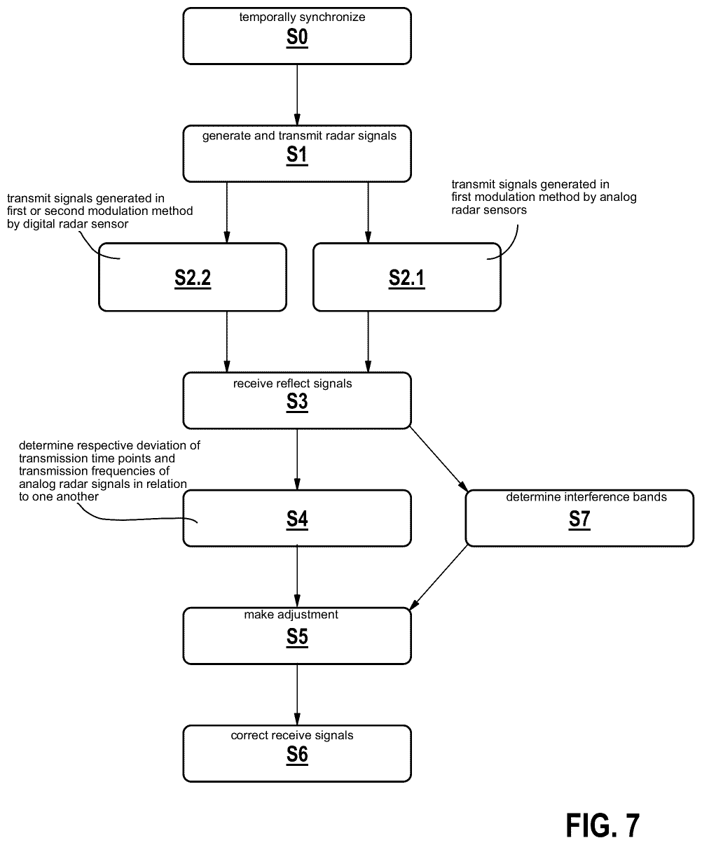

FIG. 7 shows a schematic illustration of the method steps of the method according to the presnet invention with interference detection and subsequent adjustment. For all steps that are identical to FIG. 6, the description is not repeated below. The method of FIG. 7 furthermore comprises a step S7 of determining the interference bands without and/or with very low interference from the signals received by the at least one digital radar sensor. The digital radar sensor receives all transmitted signals (step S3). As a result, it is also possible to determine the frequency bands that have no interference or low interference. Preferably, such frequency bands are determined in the frequency range used by the analog radar sensors. Step S7 is performed simultaneously with step S4, for example. The interference determination can thus take place without affecting the further method and thus the operation of the radar network operated therewith. However, the determination of the interference bands may, for example, also be performed before or after the determination of the deviation (step S4), which reduces the required computing capacity.

Furthermore, in step S5, the signals are adjusted to the frequency bands determined in step S7. For example, the signal frequencies are shifted along the frequency spectrum in such a way that they are in frequency bands that have no and/or only very low interference. This adjustment may be performed at the same time as the adjustment or correction of the deviations determined in step S4. By means of the method shown in FIG. 7, it is possible to operate a type of cognitive radar that can detect and avoid interference that may occur. Since the determination of the interference bands can take place in step S7 as an evaluation of the data digitally transformed in step S3, the method according to the present invention requires only increased computing capacity and no further adjustments to the radar network operated with the method.

### REFERENCE SIGNS

| | |
|---|---|
| 10 | radar system |
| 12 | vehicle |
| 14 | analog radar sensor |
| 16 | analog radar sensor |
| 18 | analog radar sensor |
| 20 | analog radar sensor |
| 22 | digital radar sensor |
| 24; 34; 44; 54 | transmission signals of the analog radar sensor |
| | 14 |
| 26; 36; 46; 56 | transmission signals of the analog radar sensor |
| | 14 |
| 28; 38; 48; 58 | transmission signals of the analog radar sensor |
| | 14 |
| 30; 40; 50; 60 | transmission signals of the analog radar sensor |
| | 14 |
| 32; 42; 52; 62 | transmission signals of the analog radar sensor |
| | 14 |

What is claimed is:

1. A method for operating a multiple-input multiple-output (MIMO) radar network, comprising the following steps:
generating and transmitting signals, wherein the transmitting of the signals includes using a plurality of analog radar sensors and at least one digital radar sensor, wherein: (i) the plurality of analog radar sensors and the at least one digital radar sensor transmit in a first modulation method, or (ii) the plurality of analog radar sensors transmits in a first modulation method and the at least one digital radar sensor transmits in a second modulation method, wherein the transmission signals of the first and the second modulation method do not overlap simultaneously in the time range and frequency range;
receiving and conditioning reflected signals for digital processing, wherein the at least one digital radar sensor receives the transmitted signals of all radar sensors;
determining a deviation of transmission time points and transmission frequencies of at least the plurality of analog radar sensors in relation to one another using the signals received by the at least one digital radar sensor;
adjusting the transmission time points, reception time points, and transmission frequencies of the signals of at least the plurality of analog radar sensors to one another;
evaluating the received signals in at least one of monostatic paths of the analog and digital radar sensors, at least one bistatic path from the at least one analog radar sensor to the digital radar sensor, respective bistatic paths between the plurality of analog radar sensors, and when the plurality of analog radar sensors and the at least one digital radar sensor transmit in the first modulation method, respective bistatic paths from the at least one digital radar sensor to the plurality of analog radar sensors.

2. The method according to claim 1, further comprising:
prior to the generating and transmitting step, temporally synchronizing the analog and digital radar sensors, wherein:
(i) the synchronization includes transmitting a separate radar signal at a predetermined time point to determine a deviation, and adjusting based on the deviation, or
(ii) the synchronization is performed using: (a) a trigger signal from at least one of the analog and digital radar sensors and/or (b) a synchronization protocol and/or (c) a clock signal.

3. The method according to claim 1, wherein:
the first modulation method is an FMCW method with Doppler division multiplexing methods (DDM) or with time division multiplexing methods (TDM) or with code division multiplexing methods (CDM), and/or
the second modulation method is an orthogonal frequency division multiplexing method (OFDM) or phase-modulated continuous wave (PMCW) method.

4. The method according to claim 1, wherein the evaluation of the signals received from the plurality of analog radar sensors includes a demodulation of the received signals.

5. The method according to claim 1, wherein:
wherein the plurality of analog radar sensors and the at least one digital radar sensor transmit in the first modulation method, the evaluation of the signals received by the at least one digital radar sensor includes separating the monostatic signals of the at least one digital radar sensor from the bistatic signals of the plurality of analog radar sensors using optimal filters; or
when the at least one digital radar sensor transmits in the second modulation method, the evaluation of the signals received by the at least one digital radar sensor includes separating the monostatic signals of the at least one digital radar sensor from the bistatic signals of the plurality of analog radar sensors using frequency masks.

6. The method according to claim 1, further comprising:
performing a method for interference detection and interference avoidance including:
determining frequency bands without and/or with very low interference from the signals received by the at least one digital radar sensor, and
adjusting transmission frequencies of the signals of at least the plurality of analog radar sensors to the frequency bands.

7. The method according to claim 6, wherein
the step of determining the frequency bands without and/or with very low interference from the signals received by the at least one digital radar sensor is performed with the step of determining the deviation of the transmission time points and transmission frequencies of at least the plurality of analog radar sensors in relation to one another using the signals received by the at least one digital radar sensor, and/or
the step of adjusting the transmission frequencies of the signals of at least the plurality of analog radar sensors to frequency bands without and/or with very low interference is performed with the step of adjusting the transmission time points, reception time points, and transmission frequencies of the signals of at least the plurality of analog radar sensors to one another.

8. A multiple-input multiple-output (MIMO) radar network comprising:
a plurality of analog radar sensors, wherein the plurality of analog radar sensors is configured to transmit and receive signals in a first modulation method;
at least one digital radar sensor, wherein the at least one digital radar sensor is designed to transmit and receive signals in the first modulation method or in a second modulation method, wherein the transmission signals of the first and the second modulation method do not overlap simultaneously in the time range and frequency range, wherein the at least one digital radar sensor is configured to receive the transmitted signals of all radar sensors, and wherein the at least one digital radar sensor and the plurality of analog radar sensors are configured designed to exchange data directly or via an exchange unit; and
a computing unit, wherein the computing unit is configured to determine a deviation of transmission time points and transmission frequencies of at least the plurality of analog radar sensors in relation to one another from the signals received by the at least one digital radar sensor, and wherein the at least one computing unit is further configured to adjust the transmission time points, reception time points, and transmission frequencies of at least the plurality of analog radar sensors to one another.

9. The radar network according to claim 8, wherein the at least one computing unit is further configured to adjust the transmission time points, reception time points, and transmission frequencies of at least the plurality of analog radar sensors to one another in such a way that an evaluation of the received signals is possible in respective bistatic paths between the plurality of analog radar sensors.

10. The radar network according to claim 8, wherein the at least one digital radar sensor and the plurality of analog radar sensors are configured to be temporally synchronized.

11. The radar network according to claim 8, wherein the radar network includes a synchronization protocol and/or a separate radar signal and/or a clock signal.

12. The radar network according to claim 8, wherein:
the first modulation method is an FMCW method with Doppler division multiplexing methods or with time division multiplexing methods (TDM) or with code division multiplexing methods (CDM), and/or
the second modulation method is an orthogonal frequency division multiplexing method (OFDM) or a phase-modulated continuous wave (PMCW) method.

13. The radar network according to claim 8, wherein:
the computing unit is further configured to evaluate the adjusted received signals in at least one of:
monostatic paths of the analog and digital radar sensors,
at least one bistatic path from the at least one analog radar sensor to the digital radar sensor, respective bistatic paths between the plurality of analog radar sensors,
when the plurality of analog radar sensors and the at least one digital radar sensor transmit in the first modulation method, respective bistatic paths from the at least one digital radar sensor to the plurality of analog radar sensors; and/or
wherein the computing unit is further configured to determine frequency bands without and/or with very low interference from the signals received by the at least one digital radar sensor and to adjust transmission frequencies of the signals of at least the plurality of analog radar sensors to the frequency bands.

14. The radar network according to claim 8, wherein the radar network is configured to, prior to the generating and transmitting step, temporally synchronize the analog and digital radar sensors, wherein:
(i) the synchronization includes transmitting a separate radar signal at a predetermined time point to determine a deviation, and adjusting based on the deviation, or
(ii) the synchronization is performed using: (a) a trigger signal from at least one of the analog and digital radar sensors and/or (b) a synchronization protocol and/or (c) a clock signal.
